(19) United States
(12) Patent Application Publication
(10) Pub. No.: US 2021/0161155 A1
(43) Pub. Date: Jun. 3, 2021

(54) IMPROVER FOR BAKED CONFECTIONERY

(71) Applicant: J-OIL MILLS, INC., Tokyo (JP)

(72) Inventors: Mina YOSHIMURA, Tokyo (JP); Keisuke SHINODA, Tokyo (JP); Yuya NAGAHATA, Tokyo (JP); Daisuke NAGASAWA, Tokyo (JP); Jun IMAGI, Tokyo (JP)

(21) Appl. No.: 17/262,925

(22) PCT Filed: Jul. 26, 2019
(86) PCT No.: PCT/JP2019/029520

§ 371 Date: Jan. 25, 2021

(30) Foreign Application Priority Data
Aug. 3, 2018 (JP) 2018-147022

(51) Int. Cl. A21D 2/18; A21D 13/80; A21D 13/60; A21D 13/44; A23L 13/00

(52) U.S. Cl. CPC A21D 2/186; A21D 13/80; A23V 2002/00; A21D 13/44; A23L 13/03; A21D 13/60

(57) ABSTRACT

An improver for a baked confectionery (here, excluding a sponge cake) includes a component. (A) satisfying conditions of (1) to (5) below: (1) a starch content is equal to or more than 75% by mass; (2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×1.0⁴; (3) a degree of swelling in cold water at 25° C. is equal to or more than 5 and equal to or less than 20; (4) a content under a sieve having a mesh size of 0.25 mm is equal to or more than 80% by mass and equal to or less than 100% by mass; and (5) a content on a sieve having a mesh size of 0.5 mm is equal to or less than 10% by mass.

### TECHNICAL FIELD

The present invention relates to an improver for a baked confectionery.

### BACKGROUND ART

As a technique relating to an improver for a baked confectionery, there are those described in Patent Documents 1 and 2 .

Patent Document 1 (Japanese Unexamined Patent Publication No. 2003-210098) describes a quality improver for confectionery or bakery containing one or more powders selected from pulverized cereal flours or starches, a processed product thereof, and decomposition product thereof. Also, it is described that by using such an improver, confectioneries or breads having a moist and melty texture and an excellent appearance such as a sense of volume can be obtained without impairing a taste, and aging during storage can be suppressed.

Also, Patent Document 2 (Japanese Unexamined Patent Publication No. 2008-73018) describes a forming agent for a baked confectionery dough containing at least one of undisintegrated pregelatinized starch and sweet potato powder, thereby regardless of a wheat flour content, formability during a step for producing a baked confectionery becomes good, and it possible to make use of an original flavor and texture of a flavor material, and impart a crushable texture which is crispy and crunchy, without affecting a flavor.

### RELATED DOCUMENT

### Patent Document

[Patent Document. 1] Japanese Unexamined Patent Publication No. 2003-210093

[Patent Document 2] Japanese Unexamined Patent Publication No. 2008-73018

### SUMMARY OF THE INVENTION

### Technical Problem

However, in a case where the technique described above is used, there is room for improvement in that a baked confectionery having excellent crispness, moist feeling, and meltability in mouth, which are preferable characteristics of a baked confectionery, is obtained even after storage.

### Solution to Problem

According to the present invention, there is provided an improver for a baked confectionery (here, excluding a sponge cake) including: a component (A) satisfying conditions of (1) to (5) below as an active ingredient.

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

According to the present invention, there is provided a dough. for a baked confectionery here, excluding a sponge cake) including: a component, (A) satisfying conditions of (1) to (5) below; and a powder raw material other than the component (A).

(1) A starch content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak. molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

According to the present invention, there is provided a mixed flour for a baked confectionery (here, excluding a sponge cake) including: a component (A) satisfying conditions of (1) to (5) below; and one or two selected from the group consisting of a cereal flour and sugars.

(1) starch content is equal to or more t an 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10 and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

According to the present invention, there is provided a baked confectionery (here, excluding a sponge cake) including: a component (A) satisfying conditions of (1) to (5) below; and a powder raw material other than the component (A).

(1) A starch content. is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

According to the present invention, there is provided a method for producing a baked confectionery (here, excluding a sponge cake) including: a step of mixing a component (A) satisfying conditions of (1) to (5) below and a powder raw material other than the component (A) to obtain a dough; and a step of baking or frying the dough.

(1) A starch content is equal to or more than 75% by mass

(2) Equal to or more than 3% by mass and equal to or less than 45% by, mass of molecular weight-reduced starch of starch having an amylose content of equal to or more than 5% by mass is contained, where the molecular weight-reduced starch has a peak. molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

According to the present invention, there is provided a method for improving a texture of a baked confectionery (here, excluding a sponge cake), including: incorporating a component (A) satisfying conditions of (1) to (5) below into a dough of the baked confectionery.

(1) A starch. content is equal to or more than 75% by mass

(2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold. water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

Also, according to the present invention, there is provided a method for suppressing a change over time of a baked confectionery (here, excluding a sponge cake), including: incorporating a component (A) satisfying conditions of (1) to (5) below into a dough of the baked confectionery.

(1) A starch content is equal to or more than 75% by mass

(2) Equal co or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

A predetermined combination of each of these configurations, or a case obtained by changing the expression of the present invention among a method, a device, and the like is also effective as an aspect of the present invention.

For example, the present invention also includes a use of the improver for a baked confectionery according to the present invention for a mixed flour for a baked confectionery (here, excluding a sponge cake), a dough for a baked confectionery (here, excluding a sponge cake), and a method for producing a baked confectionery (here, excluding a sponge cake).

In addition, the present invention also includes a use of the mixed flour for a baked confectionery or the dough for a baked confectionery according to the present. invention for a baked confectionery (here, excluding a sponge cake) and a method for producing the same.

### Advantageous Effects of Invention

According to the present invention, it is possible to obtain a baked confectionery that has excellent crispness, a moist feeling, and meltability in mouth, which are preferable characteristics of a baked confectionery, even after storage.

### BRIEF DESCRIPTION OF THE DRAWINGS

The object describe above, other objects, features, and advantages will be further clarified by the preferred embodiments to be described. below and the accompanying drawings below.

FIG. 1 shows a diagram showing evaluation results of a baked confectionery in examples by a texture analyzer.

FIG. 2 shows a diagram showing evaluation results of a baked confectionery in examples by a texture analyzer.

### DESCRIPTION OF EMBODIMENTS

Hereinafter, embodiments of the present: invention will be described with reference to specific examples of each component. Each component can be used alone or two or more kinds thereof can be used in combination.

(Improver for Baked Confectionery)

In the present embodiment, an improver for a baked confectionery (here, excluding a sponge cake) contains a component (A) satisfying conditions of (1) to (5) below, as an active ingredient.

(1) A starch content is equal to or more than 75% by mass (2) Equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴

(3) A degree of swelling in cold water at 25° C. is equal to or more than 5 and equal to or less than 20

(4) A content under a sieve having a mesh size of 0.25 mm is equal to or more than 80% by mass and equal to or less than 100% by mass

(5) A content on a sieve having a mesh size of 0.5 mm is equal to or less than 10% by mass

In the present specification, the baked confectionery does not include a sponge cake. A sponge cake refers to a baked confectionery characterized by a dough that uses an egg, a sugar, and a wheat flour, uses foaming properties of the egg, and has good meltability in mouth and a low specific gravity. Specifically, the specific gravity of the dough of the sponge cake before baking is equal to or more than 0.3 and equal to or less than 0.6.

Tn addition, the baked confectionery may be any baked confectionery other than the sponge cake. From a viewpoint of more preferably obtaining an effect of the improver for a baked confectionery, the baked confectionery is preferably one selected from the group consisting of a pound cake, a madeleine, a pancake, a waffle, a corn dog, and a donut. Here, the pound cake refers to a baked confectionery characterized by a batter dough that uses the same amount of an egg, a sugar, an oil, and a wheat flour, is to enjoy a natural flavor of the dough, and has a large specific gravity. The specific gravity of the dough of the pound cake before baking is larger than that of the sponge cake, for example, more than 0.6.

A method for measuring the specific gravity of the dough is not limited and may be a generally used method. For example, the specific gravity can be calculated by leveling off the dough in a plastic cup or the like having a capacity of 100 mL, which has been weighed in advance, and measuring the mass.

Hereinafter, the component (A) will be described in more detail.

(Component (A))

Specifically, the component (A) is a powder containing starch as a main component.

Regarding the condition of (1), the component (A) contains the starch in an amount of equal to or more than 75% by mass, preferably equal to or more than 80% by mass, and still more preferably equal to or more than 85% by mass, from viewpoints of improving the moist feeling and the meltability in mouth of the baked confectionery and suppressing a change over time thereof.

Also, an upper limit of the starch content in the component (A) is not limited and is equal to or less than 100% by mass, or may also be equal to or less than 99.5% by mass, equal to or less than 99% by mass, and the like, according to properties of the baked confectionery.

Regarding the condition of (2), the component (A) contains, as the starch, a molecular weight-reduced starch which uses starch having an amylose content of equal to or more than 5% by mass as a raw material, in a specific ratio, and a molecular weight-reduced starch having a specific size is used. That is, the starch n the component contains equal to or more than 3% by mass and equal to or less than 45% by mass of the molecular weight-reduced starch which uses the starch having the amylose content of equal to or more than 5% by mass as a raw material in the component (A), and the peak molecular weight of the molecular weight-reduced starch is equal to or more than 3×10³ and equal to or less than 5×10⁴.

The molecular weight-reduced starch has a peak molecular weight of equal to or more than 3×10³ and preferably equal to or more than 8×10³, from the viewpoints of improving the moist feeling and the meltability in mouth of the baked confectionery and suppressing a change over time thereof. Also, from viewpoints of improving crispness of the baked confectionery and suppressing a change over time thereof, the molecular weight-reduced starch has the peak molecular weight of equal to or less than 5×10⁴, preferably equal to or less than 3×10¹, and still more preferably equal to or less than 1.5×10⁴. A method for measuring peak molecular weight of the molecular weight-reduced starch will be described in a section of Examples.

From a viewpoint of excellent production stability, the molecular weight-reduced starch is preferably one or more selected from the group consisting of acid-treated starch, oxidation-treated starch, and enzyme-treated starch, and more preferably the acid-treated starch.

A condition of an acid treatment when obtaining the acid-treated starch is not limited, and a treatment can be performed as follows, for example.

First, starch having the amylose content of equal to or more than 5% by mass and water which are raw materials are added to a reaction device, and then acid is further added thereto. Alternatively, acid water, in which an inorganic acid is previously dissolved in water, and the starch as a raw material are added to the reaction device. From a viewpoint of more stably performing the acid treatment., it is desirable that a total amount of the starch in the reaction is in a state of being uniformly dispersed in an aqueous phase or in a slurry state. For the purpose, a concentration of the starch slurry in the acid treatment is adjusted to be in a range, for example, equal to or more than 10% by mass and equal to or less than 50% by mass, and preferably equal to or more than 20% by mass and equal to or less than 40% by mass. When the slurry concentration is too high, slurry viscosity may increase, and it may be difficult to stir the slurry uniformly, in some cases.

Specific examples of the acid used for the acid treatment include inorganic acids such as hydrochloric acid, sulfuric acid, and nitric acid, which can be used regardless of a kind, purity, and the like.

In a condition of the acid treatment reaction, for example, a concentration of the inorganic acid during the acid treatment is preferably equal to or more than 0.05 Normality (N) and equal to or less than 4 N, more preferably equal to or more than 0.1 N and equal to or less than 4 N, and still more preferably equal to or more than 0.2 N and equal to or less than 3 N, from a viewpoint of stably obtaining the acid-treated starch. In addition, from the same viewpoint, a reaction temperature is preferably equal to or higher than 30° C. and equal to or lower than 70° C., more preferably equal to or higher than 35° C. and equal to or lower than 70° C., and still more preferably equal to or higher than 35° C. and equal to or lower than 65° C. From the same viewpoint, a reaction time is preferably equal to or longer than 0.5 hours and equal to or shorter than 120 hours, more preferably equal to or longer than 1 hour and equal to or shorter than 72 hours, and still more preferably equal to or longer than 1 hour and equal to or shorter than 48 hours.

A content of the molecular weight-reduced starch in the component (A) is equal to or more than 3% by mass, preferably equal to or more than 8% by mass, and still more preferably equal to or more than 13% by mass, from viewpoints of improving the crispness of the baked confectionery and suppressing a change over time thereof.

On the other hand, an upper limit of the content of the molecular weight-reduced starch in the component (A) is equal to or less than 45% by mass, preferably equal to or less than 35% by mass, and still more preferably equal to or less than 25% by mass, from the viewpoints of improving the balance between the crispness, the moist feeling, and the meltability in mouth of the baked confectionery.

In addition, the amylose content in the raw material starch of the molecular weight-reduced starch is equal to or more than 5% by mass, and from the viewpoint of improving the crispness of the baked confectionery, preferably equal to or more than 12% by mass, still more preferably equal to or more than 22% by mass, still further preferably equal to or more than 40% by mass, even more preferably equal to or more than 45% by mass, and particularly preferably equal to or more than 55% by mass. An upper limit of the amylose content in the raw material starch of the molecular weight-reduced starch is not limited, and is equal to or less than 100% by mass, and preferably equal to or less than 90% by mass.

As the starch which is the raw material of the molecular weight-reduced starch and has the amylose content of equal to or more than 5% by mass, one or more selected from the group consisting of high amylose corn starch, corn starch, tapioca starch, sweet potato starch, potato starch, wheat starch, high amylose wheat starch, rice starch, and processed starch obtained by processing these raw materials chemically, physically or enzymatically can be used. From the viewpoints of improving the crispness of the baked confectionery and suppressing the change over time thereof, it is preferable to use one or more selected from high amylose corn starch, corn starch, and tapioca starch. In addition, from the viewpoints of improving the balance between the crispness, the moist feeling, and the meltability in mouth of the baked confectionery, the starch having the amylose content of equal to or more than 5% by mass is preferably a high amylose corn starch. The high amylose corn starch having the amylose content of equal to or more than 40% by mass is available. The starch having the amylose content of equal to or more than 5% by mass is more preferably corn starch having the amylose content of equal to or more than 40% by mass.

Also, the component (A) has a configuration in which the degree of swelling cold water satisfies the specific condition of (3) and a particle size satisfies the specific conditions of (4) and (5).

First, regarding the condition of (3), the component (A) has a degree of swelling in cold water of equal to or more than 5, preferably equal to or more than 6, and still more preferably equal to or more than 6.5, from viewpoints of improving the moist feeling and the meltability in mouth of the baked confectionery and suppressing a change over time thereof.

In addition, from the viewpoints of improving the crispness of the baked confectionery and suppressing the change over time thereof , the component (A) has a degree of swelling in cold water of equal to or less than 20, preferably equal to or less than 17, and still more preferably equal to or less than 15.

Here, a method for measuring the degree of swelling in cold water of the component (A) will be described in a section of Examples.

Next, the particle size for the component (A) will be described.

Regarding the condition of (4), the content of particles under a sieve having a mesh size of 0.25 mm is equal to or more than 80% by mass, preferably equal to or more than 85% by mass, still more preferably equal to or more than 90% by mass, and even more preferably equal to or more than 95% by mass, with respect to the entirety of the component (A), from the viewpoints of improving the crispness, the moist feeling, and the meltability in mouth of the baked confectionery and suppressing the change over time thereof.

In addition, an upper limit of the content of particles under a sieve having a mesh size of 0.25 mm is not limited and is equal to or less than 100% by mass.

In addition, regarding the condition of (5), the content of particles on a sieve having a mesh size of 0.5 mm is equal to or less than 10% by mass, preferably equal to or less than 5% by mass, still more preferably equal to or less than 3% by mass, even more preferably equal to or less than 1% by mass, and even further preferably 0% by mass, with respect to the entirety of the component (A), from the viewpoints of improving the meltability in mouth of the baked confectionery and suppressing the change over time thereof.

In addition, a lower limit of the content of particles of component (A) on a sieve having a mesh size of 0.5 mm is not limited and is equal to or more than 0% by mass.

In addition, regarding the particle size of the component (A), the content of particles on a sieve having a mesh size of 0.075 mm is preferably equal to or more than 10% by mass, still more preferably equal to or more than 30% by mass, and even more preferably equal to or more than 50% by mass, and further more preferably equal to or more than 70% by mass with respect to the entirety of the component (A), from the viewpoints of improving the crispness, the moist feeling, and the meltability in mouth of the baked confectionery and suppressing the change over time thereof.

In addition, an upper limit of the content of particles on a sieve having the mesh size of 0.075 mm is not limited, is equal to or less than 100% by mass, and preferably equal to or less than 99% by mass and still more preferably equal to or less than 94% by mass.

In the present embodiment, the component (A) contains starch other than the molecular weight-reduced starch. Various starch can be used as a starch component other than the molecular weight-reduced starch in the component (A). Specifically, starch generally available on the market can be selected depending on use. For example, in a case of starch for foods, regardless of a kind, one or more kinds of starch such as corn starch, potato starch, tapioca starch, and wheat starch; processed starch obtained by processing these starch chemically, physically, or enzymatically; and the like can be appropriatel, selected. Preferably, one or more starch selected from the group consisting of the corn starch, the wheat starch, the potato starch, the tapioca starch, and crosslinked starch thereof may be contained.

In addition, a component other than the starch can be blended with the component (A) in the present embodiment.

Specific examples of the component other than the starch include insoluble salt such as a pigment, calcium carbonate, and calcium sulfate. It is preferable to blend the insoluble salt, and it is more preferable that a blending amount of the insoluble salt is equal to or more than 0.1% by mass and equal to or less than 2% by mass.

Next, a method for producing the component (A) will be described. The method for producing the component (A) includes, for example, the following steps.

(Step of preparing molecular weight-reduced starch) A step of reducing the molecular weight of the starch having the amylose content of equal to or more than 5% by mass to obtain the molecular weight-reduced starch having a peak molecular weight of equal to or more than 3×10³ and equal to or less than 5×10⁴.

(Granulation step) A step of granulating, by heat gelatinization, the raw material in which equal to or more than 3% by mass and equal to or less than 45% by mass of the molecular weight-reduced starch is contained, and the total amount of molecular weight-reduced starch and starch other than the molecular weight-reduced starch is equal to or more than 75% by mass.

The step of preparing the molecular weight-reduced starch is a step of decomposing starch having the amylose content of equal to or more than 5% by mass into the molecular weight-reduced starch. The decomposition referred to here refers to decomposition accompanied by molecular weight reduction of starch, and examples of a typical decomposition method include decomposition by an acid treatment or an oxidation treatment, and an enzyme treatment. Among the treatments, acid treatment is preferable from the viewpoints of a decomposition rate or costs, and reproductibility of a decomposition reaction.

Further, in the granulation step, a general method used for granulating starch can be used, and it is preferable to use a general method used for heat gelatinization of starch, in terms of achieving a predetermined degree of swell in cold water. Specifically, a method using a machine such as a drum dryer, a jet cooker, an extruder, or a spray dryer is known. However, in the present embodiment, from the viewpoint of more reliably obtaining the component (A) in which the degree of swelling in cold water satisfies the above-mentioned specific condition, the heat gelatinization with the extruder or the drum dryer is preferable, and the extruder is more preferable.

According to a method using an extrusion granulator using an extruder or the like, at least the vicinity of the surface of the particles of he component (A) is gelatinized, and a starch powder having an appropriately low density is obtained Therefore, it is possible to further stably obtain the component (A) having an appropriately high water absorption rate and an excellent effect of suppressing water separation. In a case of an extruder treatment, usually, water is added to a raw material containing starch to adjust the moisture content to about 10% to 60% by mass, and then heated and swelled, for example, in conditions of a barrel temperature of 30° C. to 200° C., an outlet temperature of 80° C. to 180° C., a screw rotation speed of 100 to 1,000 rpm, and a heat treatment time of 5 to 60 seconds.

In the present embodiment, for example, by the step of heat-gelatinizing the specific raw material, the component (A) in which the degree of swelling in cold water satisfies a specific condition can be obtained.

In addition, the component (A) satisfying conditions of (4) and (5) may be obtained by, as needed, pulverizing and sieving a granulated product obtained by heat gelatinization and appropriately adjusting a size thereof.

The component (A) obtained as above is a starch powder containing the molecular weight-reduced starch and is configured to satisfy the conditions of (1) to (5). Therefore, the component (A) is blended with the baked confectionery, whereby it is possible to improve a texture of baked confectionery and it is possible to suppress a change over time of the texture.

For example, in the present embodiment, a method for improving the texture of baked confectionery (here, excluding a sponge cake) includes incorporating the component (A) into the dough of the baked confectionery.

In addition, in the present embodiment, a method for suppressing a change over time of the baked confectionery (here, excluding a sponge cake) includes incorporating the component (A) into the dough of the baked confectionery.

In the present specification, the texture of the baked confectionery specifically refers to crispness, a moist feeling, and meltability in mouth, which are preferable characteristics of a baked confectionery.

In addition, in the present specification, suppressing the change over time of the baked confectionery refers to, for example, suppressing adeterioration of the texture of the baked, confectionery described above when the baked confectionery is stored.

In the present embodiment, by blending the improver for a baked confectionery containing the component (A) as an active ingredient to obtain a baked, confectionery, it is possible to improve the balance of the crispness, the moist feeling, and the meltability in mouth peculiar to a baked confectionery and it is possible to suppress the change over time of these textures.

A content of the component (A) in the improver for a baked confectionery is preferably equal to or more than 50% by mass, still more preferably equal to or more than 80% by mass, and even more preferably equal to or more than 90% by mass, with respect to the entirety of the improver for a baked confectionery, from the viewpoints of improving the crispness, the moist feeling, and the meltability in mouth of the baked confectionery and suppressing the change over time thereof.

Also, an upper limit of the content of the component (A) in the improver for a baked confectionery is not limited and is equal to or less than 100% by mass, and may also be, for example, equal to or less than 99% by mass.

In addition, the improver for a baked confectionery is preferably made of the component (A).

When the improver for a baked confectionery contains a component other than the component (A), examples of the component other than the component (A) include starch, a cereal flour, a pH adjuster, and sugars.

(Dough for Baked Confectionery)

In the present embodiment, the dough for a baked confectionery contains the component (A) and a powder raw material other than the component (A).

The powder raw material, is a raw material that is blended in a powdery form in the dough for a baked confectionery and is a raw material other than the component (A). Specific examples of the powder raw material include a cereal flour such as a wheat flour and a soybean flour; proteins such as gluten and soybean protein; sugars such as sugar, fructose, glucose, somerized sugar, converted sugar, oligosaccharide, starch, dextrin, trehalose, sugar alcohol (such as maltitol, erythritol, sorbitol, xylitol, and lactitol), and powdered sweeteners such as aspartame, acesulfam potassium, advantame, sucralose, ariteme, neotheme, saccharin, and stevia extract; dietary fiber such as bran, cellulose, and indigestible dextrin; leavening agent such as a baking powder; milks such as a skim milk powder, a full-fat milk powder, and a cheese powder; eggs such as egg white powder and whole egg powder; thickening polysaccharides such as guar gum and alginate; an emulsifier; flavoring materials such as a cocoa powder and a matches powder; and a flavor and a flavor improver. From the viewpoint of obtaining the baked confectionery having excellent production stability, the powder raw material preferably contains the cereal flour, and still more preferably contains the wheat flour.

The content of the component (A) with respect to the total content of the powder raw material and the component (A) in the dough for a baked confectionery is preferably equal to or more than 0.3% by mass, more preferably equal to or more than 0.5% by mass, still more preferably equal to or more than 1.0% by mass, still further preferably equal to or more than 1.2% by mass, and even more preferably equal to or more than 1.5% by mass, from the viewpoints of improving the crispness, the moist feeling, and the meltability in mouth of the baked confectionery and suppressing the change over time thereof.

Also, the content of the component (A) with respect to the total content of the powder raw material and the component (A) in the dough for a baked confectionery is preferably equal to or less than 25% by mass, more preferably equal to or less than 22% by mass, still more preferably equal to or less than 15% by mass, still further preferably equal to or less than 12% by mass, even more preferably equal to or less than 10% by mass, and particularly preferably equal to or less than 8% by mass.

Here, in the present specification, the “total content of the powder raw material and the component (A)” is the total of the component (A) and the powder raw material other than the component (A).

The content of the component (A) with respect to the total content of the cereal flour and the component in the dough for the baked confectionery is preferably equal to or more than 1% by mass, more preferably, equal to or more than 2% by mass, still more preferably equal to or more than 4% by mass, and still further preferably equal to or more than 7% by mass, from the viewpoints of improving the crispness, the moist feeling, and the meltability in mouth of the baked confectionery and suppressing the change over time thereof.

In addition, the content of the component (A) with respect to the total content of the cereal flour and the component (A) in the dough for a baked confectionery may be, for example, equal to or less than 30% by mass, and is preferably equal to or less than 20% by mass, more preferably equal to or less than 15% by mass, and still more preferably equal to or less than 12% by mass.

Also, the dough for a baked confectionery may contain a component other than the component (A) and the powder raw material described above Specific examples of the other component include an egg liquid such as whole eggs, egg whites, and egg yolks; edible oils and fats such as liquid oils and solid fats; liquids such as water, milk, soymilk, fruit juice, honey, black honey, and maple syrup; nuts; and dried fruits.

(Mixed Flour for Baked Confectionery)

In the present embodiment, a mixed flour for a baked confectionery contains the component (A) and one or two selected from the group consisting of a cereal flour and sugars.

As specific examples of the cereal flour and the sugars, those exemplified as the cereal flour and the sugars to be blended in the dough for a baked confectionery can be used, respectively.

The content of the component (A) in the mixed flour for a baked confectionery is preferably equal to or more than 1.2% by mass, and still more preferably equal to or more than 1.5% by mass, with respect to the entirety of a mixed flour for a baked confectionery, from the viewpoints of improving the crispness, the moist feeling, and the meltability in mouth of the baked confectionery and suppressing the change over time thereof.

Also, the content of the component (A) in the mixed flour for a baked confectionery is less than 100% by mass, more preferably equal to or less than 90% by mass, still more preferably equal to or less than 80% by mass, still further preferably equal to or less than 70% by mass, and particularly preferably equal to or less than 60% by mass, with respect to the entirety of the mixed flour for a baked confectionery.

(Baked Confectionery)

In the present embodiment, the baked confectionery contains the component (A) and a powder raw material other than the component (A). As the powder raw material, those exemplified as the powder raw material to be blended in the dough for a baked confectionery can be used.

The content of the component (A) with respect to the total content of the powder raw material and the component (A) in the baked confectionery is preferably equal to or more than 0.3% by mass, still more preferably equal to or more than 0.5% by mass, even more preferably equal to or more than 1.0% by mass, still further preferably equal to or more than 2.0% by mass, and even further preferably equal to or more than 3.5% by mass, from the viewpoints of improving the crispness, the moist feeling, and the meltability in mouth of the baked confectionery and suppressing the change over time thereof.

Also, from the same viewpoint, the content of the component (A) with respect to the total content of the powder raw material and the component (A) in the baked confectionery is preferably equal to or less than 25% by mass, more preferably equal to or less than 22% by mass, still more preferably equal to or less than 15% by mass, still further preferably equal to or less than 12% by mass, even more preferably equal to or less than 10% by mass, and particularly preferably equal to or less than 8% by mass.

The content of the component (A) with respect to the total content of the cereal flour and the component (A) in the baked confectionery is preferably equal to or more than 1% by mass, more preferably, equal to or more than 2% by mass, still more preferably equal to or more than 4% by mass, and still further preferably equal to or more than 7% by mass, from the viewpoints of improving the crispness, the moist feeling, and the meltability in mouth of the baked confectionery and suppressing the change over time thereof.

In addition, the content of the component (A) with respect to the total content of the cereal flour and the component (A) in the baked confectionery may be, for example, equal to or less than 30% by mass, and is preferably equal to or less than 20% by mass, more preferably equal to or less than 15% by mass, and still more preferably equal to or less than 12% by mass.

In addition, the baked confectionery may contain a component other than the component (A) and the powder raw material described above, and specific examples of the other component include the components described above for dough for a baked confectionery.

In the present embodiment, the baked confectionery can be obtained by, for example, a production method including a step of mixing the component (A) and the powder raw material other than the component (A) to obtain a dough; and a step of baking or frying the dough.

Since the baked confectionery obtained in the present embodiment contains the component (A) as an active ingredient, it is possible to improve the balance of the crispness, the moist feeling, and the meltability in mouth peculiar to a baked confectionery and it is possible to suppress the change over time of these textures.

In addition, according to the present embodiment, for example, it is possible to obtain a baked confectionery which has an excellent balance of the meltability in mouth, the moist feeling, and crunch crispness, and in which changes in these textures due to storage are suppressed. More specifically, according to the present embodiment, it is also possible to obtain a baked confectionery in which the change in the texture is suppressed when stored at 20° for equal to or longer than 1 day, equal to or longer than 3 days, equal to or longer than 7 days, or equal to or longer than 14 days, for example. Also, it is also possible to obtain a baked confectionery in which the change in the texture is suppressed when stored at a temperature of equal to or higher than 50° C. and equal to or lower than 80° C. for equal to or longer than 1 day, equal to or longer than 3 days, equal to or longer than 7 days, or equal to or longer than 14 days, for example. Also, it is also possible to obtain a baked confectionery in which the change in the texture is suppressed when stored at a temperature of higher than 0° C. and equal to or lower than 10° C. for equal to or longer than 1 day, equal to or longer than 3 days, equal to or longer than 7 days, or equal to or longer than 14 days, for example.

### EXAMPLES

Examples of the present invention will be shown below, but the gist of the present invention is not limited thereto.

(Raw Material)

The following raw materials were mainly used.

(Starch)

β-starch: Corn starch Y, manufactured by J-OIL MILLS, INC.

High amylose corn starch: HS-7, manufactured by J-OIL MILLS, INC., amylose content of 70% by mass

Processed starch (powder raw material): JELCALL CB-10, manufactured by J-OIL MILLS, INC.

(Oil and Fat Product)

Oil and fat product 1 (processed oil and fat): “Meister Generta”, manufactured by J-OIL MILLS, INC.

Oil and fat product 2 (processed oil and fat): “Splendor L”, manufactured by J-OIL MILLS, INC.

Oil and fat product 3 (processed oil and fat): “Gran Master Genuine”, manufactured by J-OIL MILLS, INC.

Oil and fat product 4 (processed oil and fat): “Gran Master Petit Beurre”, manufactured by J-OIL MILLS, INC.

Oil and fat product 5 (processed oil and fat): Gran master Alfille, manufactured by J-OIL MILLS, INC.

Oil and fat product 6 (processed oil and fat): “Grand Master Switzar”, manufactured by J-OIL MILLS, INC.

Oil and fat product 7: “Splendor HG”, manufactured by J-OIL MILLS, INC.

Oil and fat product 8: “Meister Gold Super”, manufactured by J-OIL MILLS, INC.

Oil and fat product 9: “Grand Master Primeran”, manufactured by J-OIL MILLS, INC.

Oil and fat product 10: Rapeseed oil, manufactured by J-OIL MILLS, INC.

(Others)

Soft flour (powder raw material): “Flour”, manufactured by Nisshin Foods Inc

Baking powder (powder raw material): “F-up”, manufactured by Aikoku Co., Ltd.

Sugar (powder raw material): White sugar, manufactured by Mitsui Sugar Co., Ltd.

Palm oil: Palm oil, manufactured by J-OIL MILLS, INC.

Milk: “Bokujo-Umare no unyu (Fresh Milk at Farm)” manufactured bey Meiji Tokaisha

Honey: “Funwari Renge Hachimitsu (Soft Astragalus honey) ” manufactured by Kato Bihouen Honpo Co., Ltd.

(Production Example 1) Production of Starch Powder

In the present example, acid-treated starch was used as the molecular weight-reduced star,. to obtain the starch powder.

(Method for Producing Acid-Treated High-Amylose Corn Starch)

High amylose corn starch was suspended in water to prepare 35.5% (w/w) slurry, and was heated to 50° C. A reaction was started by adding an aqueous hydrochloric acid solution prepared to be 4.25 N in an amount of 1/9 times in terms of a mass ratio of the slurry while stirring. After reacting for 15 hours, it was neutralized with 3% NaOH, washed with water, dehydrated, and dried to obtain acid-treated high-amylose corn starch.

The peak molecular weight of the obtained acid-treated high-amylose corn starch was measured by a method below, as a result, the peak molecular weight was 1.2×10⁴.

(Method for Measuring Peak Molecular Weight)

The peak molecular weight was measured using an HPLC unit manufactured by Tosoh Corporation (Pump DP-8020, RI detector RS-8021, and Degassing device SD-8022).

(1) A sample was pulverized, and a fraction under a sieve having a mesh size of 0.15 mm was collected using a sieve of JIS-Z8801-1 standard. This collected fraction was suspended in a mobile phase so as to be 1 mg/mL, and the suspension was heated at 100° C. for 3 minutes to completely dissolve. Filtration was performed using a 0.45 μm filtration filter (manufactured by ADVANTEC, DISMIC-25HP PTFE 0.45 μm), and a filtrate was used as an analytical sample.

(2) A molecular weight was measured under the following analysis conditions.

Column: Two columns of TSKge1 α-M (7.8 mmφ, 30 cm) (made by Tosoh Corporation)

Flow rate: 0.5 mL/min

Mobile phase: 5 mM NaNO₃-containing dimethyl sulf oxide solution at 90% (v/v)

Column temperature: 40° C.

Analytical volume: 0. 2 mL

(3) The detector data was collected by software (multi-station GPC-8020 model II data collection ver 5.70, manufactured by Tosoh Corporation), and the molecular weight peak was calculated.

For a calibration curve, Pullulan with a known molecular weight (Shodex Standard P-82, manufactured by Showa Denko K K) was used.

(Method for Producing Starch Powder)

79% by mass of β-starch, 20% by mass of acid-treated high-amylose corn starch obtained by the above method, and 1% by mass of calcium carbonate were mixed in a bag to be sufficiently uniform. A mixture was heat-treated under pressure using a twin-screw extruder (KEI-45 manufactured by Kowa Industry Co., Ltd.). Processing conditions are as follows.

Raw material supply: 450 g/min

Water addition: 17% by mass

Barrel temperature: 50° C., 70° C., and 100° C. from the raw material inlet to the outlet

Outlet temperature: 100° C. to 110° C.

Screw rotation. speed of 250 rpm

A heat-gelatinize d product obtained. by the extruder treatment in this manner was dried at 110° C. to adjust the moisture content to about 10% by mass.

Next, the dried heat-gelatinized product was pulverized with a desktop cutter pulverizer and then sieved using a sieve of JIS-Z8801-1 standard. The sieved heat-gelatinized product was mixed at the following blending ratios to prepare the starch powders 1 to 4 to be described below, and the degree of swelling in cold water of each starch powder was measured by a method to be described later. Table 1 summarizes mass ratios and the degree of swelling in cold water of each fraction of starch powders 1 to 4.

(Method Formeasuring Degree of Swelling in Cold Water)

(1) A sample was dried by heating at 125° C. using a moisture meter (model number MX-50, manufactured by Kensei Kogyo Co., Ltd.) to measure the moisture, and the mass of dry matter was calculated from a moisture value obtained.

(2) 1 g of the sample in terms of the mass of dry matter was in a state of being dispersed in 50 mL of water at 25° C., gently stirred in a constant temperature bath at 25° C. for 30 minutes, and then centrifuged at 3000 rpm for 10 minutes (Centrifuge: Hitachi desktop centrifuge CTGE type, manufactured by Hitachi Koki Co., Ltd.,; Rotor: T4SS type swing rotor; and Adapter: 50TC×2S adapter), and separated into a sediment layer and a supernatant layer.

(3) The supernatant layer was removed, the mass of the sediment layer was measured, and this mass was set as B (g).

(4) The mass when the sediment layer was dried and solidified (105° C., constant weight) was set as C (g).

(5) A value obtained by dividing B by C was set as the degree of swelling in cold water.

### Examples 1 to 6, Comparative Example 1, and Control Examples 1 and 2

In the present example, a pound cake was prepared by the all-in-mix method and evaluated. In each of Examples and Comparative Examples, an improver for a baked confectionery made of any one of the starch powders 1 to 4 obtained in Production Example 1 was used. In addition, in the control example, a pound cake was produced without blending any of the starch powders 1 to 4. The blending in each example is shown in Tables 2 and 3.

Further, in Tables 2 and 3, and Table 4 and next tables to be described later, “powder raw material+starch powder” is the total of the starch powder and the powder raw material other than the starch powder.

A procedure for producing a pound cake is shown below.

1. Among the raw materials, all powder raw materials were put into a plastic bag, mixed, and sieved to prepare a mixed flour.

2. The oil and fat product 1 and the oil and fat product 2 whose temperatures were adjusted to 20° C., the white sugar, and the whole egg were put into a bowl of a hobart mixer together with the mixed flour, mixed at low speed using a beater, and then mixed at a medium speed to prepare a dough so that the final dough specific gravity was 0.75 to 0.8:1.

3. The dough obtained in above 2. was put into a pastry bag, and 300 g each was put into a pound cake baking mold.

4. The pound mold was lightly dropped on a workbench plane to shape the dough.

5. The dough was baked in an oven under the following conditions to obtain a pound cake.

Baking temperature: Upper part 180° C./Lower part 180° C.

Baking time: 37 minutes

The pound cake obtained in each example was placed in a plastic bag, sealed, and stored at 20° C. for 14 days. Then, the moist feeling, the meltability in mouth, and crispness of the pound cake of each example after storage were evaluated with respect to Control Example after storage. The evaluation results are shown in Tables 2 and 3.

The evaluation was performed by the consensus of five specialized panelists. For each item, Control Example after storage was set as a score of 0, and the evaluation was made on a 7-point scale having scores from −3 to +3, and a score of more than 0 was set as a pass. Evaluation criteria for each item are as follows.

(Moist Feeling)

Score 3: very moist

Score 2: Moist.

Score 1: Slightly moist.

Score 0: Slightly dry (same as Control Example)

Score −1: Dry

Score −2: Quite dry

Score −3: very dry

(Meltability in Mouth)

Score 3: Very good meltability in mouth

Score 2: Good meltability in mouth

Score 1: Slightly good meltability in mouth

Score 0: Slightly poor meltability in mouth (same as Control Example)

Score −1: Slightly poor meltability in mouth and a little foreign body sensation

Score −2: Poor meltability in mouth and foreign body sensation

Score −3: Very bad meltability in mouth and quite a foreign body sensation

(Crispness)

Score 3: very crisp

Score 2: Crisp

Score 1: Slightly crisp

Score 0: A little sticky (same as Control Example)

Score −1: Slightly sticky

Score −2: Quite sticky

Score −3: Very sticky

Also, in blending of Control Example 1, Comparative Example 1 and Example 1, and Control Example 2, Example 4, and Example 6, physical properties of a sample immediately after baking and after storage at 20° C. for 1, 3, 7, or 14 days were evaluated with a texture analyzer as follows.

(Preparation of Sample for Stress Measurement)

A batter dough for a pound cake was prepared with the compositions shown in Tables 2 and 3. 15 g of the batter dough was placed in a commercially available cupcake mold (baking cup, paper, size: diameter of 5 cm, bottom of 3.8 cm, and height of 3 cm) and baked at 180° C. for the upper part and 180° C. for the lower part for 15 minutes to obtain a cake for stress measurement having 3.5 to 4 cm thickness. Immediately after baking, or after storing the cake at 20° C. for an appropriate time by sealing in a plastic bag, the stress was measured with a texture analyzer.

(Evaluation Using Texture Analyzer)

The top and bottom of the cake were cut leaving 1 cm above and below the center of the height of the cupcake, and the sample having a thickness of 2 cm was prepared and evaluated using a texture analyzer.

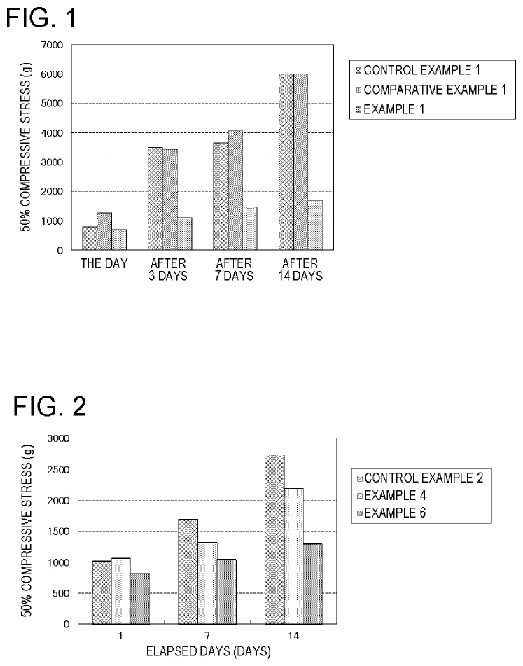

Specifically, a plunger was brought into contact with the center of the upper surface of the cut section, and the maximum stress (g) (50% compressive stress (g)) at. the time. of 50% compression was measured. Here, as a value of the 50% compressive stress (q) is smaller, it is shown that the pound cake is in a softer state. A device and measurement conditions used in the test are shown below. In addition, results are shown in FIGS. 1 and 2.

Texture analyzer

Device: TA-XT Plus (manufactured by Stable Micro Systems)

Plunger: Cylinder with a diameter of 25 mm

Test speed: 1 mm/s

An average value obtained by measuring 50% compressive stress (g) of 7 samples for each of examples (however, a value clearly understood as an error value was excluded) was use, a measured value.

TABLE 1

| | Starch | Starch | Starch | Starch |
|---|---|---|---|---|
| | powder | powder | powder | powder |
| Fraction (% by mass) | 1 | 2 | 3 | 4 |
| On a 500 μm sieve | 18 | 0 | 0 | 0 |
| Under a 500 μm sieve and | 42 | 0 | 0 | 0 |
| on a 250 μm sieve | | | | |
| Under a 250 μm sieve and | 15 | 36 | 0 | 0 |
| on a 150 μm sieve | | | | |
| Under a 150 μm sieve and | 20 | 48 | 75 | 0 |
| on a 75 μm sieve | | | | |
| Under a 75 μm sieve | 5 | 16 | 25 | 100 |
| Total | 100 | 100 | 100 | 100 |
| Degree of swelling in | 10.5 | 7.3 | 9.5 | 8.5 |
| cold water | | | | |

TABLE 2

| | | Control | Comparative | | | |
|---|---|---|---|---|---|---|
| | | Example 1 | Example 1 | Example 1 | Example 7 | Example 3 |
| Kind of starch powder | | − | Starch | Starch | Starch | Starch |
| | | | powder 1 | powder 2 | powder 3 | powder 4 |
| Raw material (part(s) by mass) | | | | | | |
| Soft flour | | 100 | 90 | 90 | 90 | 90 |
| Starch powder | | 0 | 10 | 10 | 10 | 10 |
| Sugar | | 90 | 90 | 90 | 90 | 90 |
| Baking powder | | 2 | 2 | 2 | 2 | 2 |
| Oil and fat product 1 | | 50 | 50 | 50 | 50 | 50 |
| Oil and fat product 2 | | 30 | 30 | 30 | 30 | 30 |
| Whole egg | | 100 | 100 | 100 | 100 | 100 |
| Total (part(s) by mass) | | 372 | 372 | 372 | 372 | 372 |
| Starch powder/(Powder raw | | 0 | 5.2 | 5.2 | 5.2 | 5.2 |
| material + Starch powder) | | | | | | |
| % by mass | | | | | | |
| Starch powder/(Cereal | | 0 | 10 | 10 | 10 | 10 |
| flour + Starch powder) | | | | | | |
| % by mass | | | | | | |
| Evaluation | Moist feeling | 0 | 1 | 3 | 3 | 2 |
| result | Good feeling | 0 | −2 | 3 | 3 | 3 |
| | of meltability | | | | | |
| | in mouth | | | | | |
| | Good | 0 | 2 | 3 | 3 | 3 |
| | crispness | | | | | |

From Table 2, in terms of the moist feeling after storage at 20° C. for 14 days, Examples 1 to 3, that is, all examples using: a starch powder 2 that contains 36% by mass under a 250 μm sieve and on a 150 μm sieve and 48% by mass under a 150 μm sieve and on a 75 μm sieve; a starch powder 3 that contains no particles under a 250 μm sieve and on a 150 μm sieve and 75% by mass under a 150 μm sieve and on a 75 μm sieve; and a starch powder 4 that has 100% by mass under 75 μm sieve were good, and among these, Examples 1 and 2 using the starch powders 2 and 3 were very good.

In terms of good meltability in mouth and good crispness after storage at 20° C. for 14 days, Examples 1 to 3, that is, all examples using: the starch powder 2 that contains 36% by mass under a 250 μm sieve and on a 150 μm sieve and 48% by mass under a 150 μm sieve and on a 75 μm sieve; the starch powder 3 that contains no particles under a 250 μm sieve and on a 150 μm sieve and 75% by mass under a :150 μm sieve and on a 75 μm sieve; and the starch powder 4 that has 100% by mass under 75 μm sieve were very good.

On the other hand, in Comparative Example 1 using the starch powder 1 containing 60% by mass on a 250 μm sieve, there was a feeling that lumps sometimes remained in the mouth as compared with Control Example 1, and the meltability, in mouth was not good.

TABLE 3

| | | Control | | | |
|---|---|---|---|---|---|
| | | Example 2 | Example 4 | Example 5 | Example 6 |
| Kind of starch powder | | — | Starch | Starch | Starch |
| | | | powder 2 | powder 2 | powder 2 |
| Raw material (part(s) by mass) | | | | | |
| Soft flour | | 100 | 97 | 95 | 90 |
| Starch powder | | 0 | 3 | 5 | 10 |
| Sugar | | 90 | 90 | 90 | 90 |
| Baking powder | | 2 | 2 | 2 | 2 |
| Oil and fat product 3 | | 26.7 | 26.7 | 26.7 | 26.7 |
| Oil and fat product 4 | | 23.3 | 23.3 | 23.3 | 23.3 |
| Oil and fat product 2 | | 30 | 30 | 30 | 30 |
| Whole egg | | 100 | 100 | 100 | 100 |
| Total (part(s) by mass) | | 372 | 372 | 372 | 372 |
| Starch powder/(Powder raw | | 0 | 1.6 | 2.6 | 5.2 |
| material + Starch powder) | | | | | |
| % by mass | | | | | |
| Starch powder/(Cereal | | 0 | 3 | 5 | 10 |
| flour + Starch powder) | | | | | |
| % by mass | | | | | |
| Evaluation | Moist feeling | 0 | 2 | 2 | 3 |
| result | Good feeling | 0 | 1 | 2 | 3 |
| | of meltability | | | | |
| | in mouth | | | | |
| | Good | 0 | 2 | 2 | 3 |
| | crispness | | | | |

From Table 3, the moist feeling and the crispness after storage at 20° C. for 14 days were good in Examples 4 to 6, that is, when numerical value of (Starch powder/(Powder raw material+Starch powder)) were equal to or more than 1.6% by mass and equal to or less than 5.2% by mass, and were the best when the numerical value was 5.2% by mass. The good meltability in mouth was good in Examples 4 to 6, that is, when a numerical value of (Starch powder/(Powder raw material+Starch powder)) was equal to or more than 1.6% by mass and equal to or less than 5.2% by mass, was better in Examples 5 and 6 in which the numerical value was equal to or more than 2.6% by mass and equal to or less than 5.2% by mass, and the best in Example 6 in which the numerical value was 5.2% by mass.

In addition, from FIGS. 1 and 2, in each Control Example and Comparative Example 1, the pound cake became harder with the lapse of the storage period at 20° C., whereas in each Example, an increase in the hardness due to storage was suppressed.

### Example 7 and Control Example 3

In the present example, a madeleine was prepared and evaluated. Table 4 shows blending and evaluation results of a madeleine.

(Method for Producing Madeleine)

1. Among the raw materials shown in Table 4, in Examples, the soft flour, the starch powder, a baking powder, and the sugar were put in a plastic bag and mixed to prepare a mixed flour. In Control Example, the soft flour, the baking powder, and the sugar were placed in a plastic bag and mixed to obtain a mixed flour.

2. The whole egg, the mixed flour obtained in above 1, were placed in a bowl and stirred uniformly with a hobart mixer equipped with a beater.

3. An oil and fat product 5 melted heating at 50° C. was added thereto, and was uniformly stirred.

4. The dough was placed at 25° C. for 1 hour.

5. The dough was put into a pastry bag, and the dough was poured into a madeleine mold (12 pieces, lens th of 260 mm, width of 180 mm, and height of 15 mm, made of silicon-processed tin) and baked in an oven under the following conditions.

Baking temperature: upper part 180° C./Lower part 180° C.

Baking time: For 11 minutes

(Evaluation Method)

A madeleine obtained in each Example was placed in a plastic bag together with an oxygen scavenger, sealed, and stored at 20° C. for 14 days. Then, the moist feeling, the meltability in mouth, and the crispness of the madeleine in Examples after storage with respect to Control Example after storage were evaluated by the same evaluation criteria as the evaluation method for the pound cake described above, respectively.

TABLE 4

| | | | Control | |
|---|---|---|---|---|
| | | | Example 3 | Example 7 |
| Kind of starch powder | | | — | Starch |
| | | | | powder 2 |
| Raw material (part(s) by mass) | | | | |
| Soft flour | | | 120 | 100 |
| Starch powder | | | 0 | 20 |
| Sugar | | | 90 | 90 |
| Baking powder | | | 3 | 3 |
| Oil and fat product 5 | | | 120 | 120 |
| Whole egg | | | 120 | 120 |
| Total (part(s) by mass) | | | 453 | 453 |
| Starch powder/(Powder raw | | | 0 | 9.4 |
| material + Starch powder) | | | | |
| % by mass | | | | |
| Starch powder/(Cereal | | | 0 | 16.7 |
| flour + Starch powder) | | | | |
| % by mass | | | | |
| | Evaluation | Moist feeling | 0 | 2 |
| | result | Good feeling | 0 | 2 |
| | | of meltability | | |
| | | in mouth | | |
| | | Good | 0 | 3 |
| | | crispness | | |

As shown in Table 4, even in the madeleine after storage at 20° C. for 14 days, in a case Example 7 in which the content of the improver formed of the starch powder 2 was 9.4% by mass as a numerical value of (Starch powder/(Powder raw material+Starch powder)), the moist feeling, the meltability in mouth, and the crispness were good.

Also, in Example 7, the content of the starch powder 2 was 16.7% by mass as the numerical value of (Starch powder/(Cereal flour+Starch powder)), and the moist. feeling, the meltability in mouth, and crispness were good.

### Example 8 and Control Example 4

In the present example, a donut was prepared and evaluated. Table 5 shows blending and evaluation results of a donut.

(Method for Producing Donut)

1. Among the raw materials shown in Table 5, in Examples, the soft flour, the starch powder, a processed starch, and a baking powder were put in a plastic bag and mixed to prepare a mixed flour. In Control Example, the soft flour, the processed starch, and the baking powder were placed in a plastic: bag and mixed to obtain a mixed flour.

2. Eggs and milk were added thereto and mixed with a mixer at a low speed for 1 minute (at the low speed for 1 minute).

3. The melted oil and fat product 6 was added thereto and, mixed with a mixer at a low speed for 1 minute and a medium speed for 15 seconds.

4. Each piece, 15 g, was squeezed into a star shape on a cooking sheet

5. The dough was fried in a palm oil at 170° C. for 3 minutes.

6. A completely cooled donut was placed in a plastic bag together with an oxygen scavenger, sealed, and stored at 20° C. for 7 days.

TABLE 5

| | Control | |
|---|---|---|
| | Example 4 | Example 8 |
| Kind of starch powder | — | Starch |
| | | powder 2 |
| Raw material (part(s) by mass) | | |
| Soft flour | 70 | 63 |
| Starch powder | 0 | 10 |
| Processed starch | 30 | 27 |
| Baking powder | 7 | 7 |
| Oil and fat product 6 | 20 | 20 |
| Whole egg | 15 | 15 |
| Milk | 166 | 166 |
| Total (part(s) by mass) | 308 | 308 |
| Starch powder/(Powder raw | 0 | 9.3 |
| material + Starch powder) | | |
| % by mass | | |
| Starch powder/(Cereal | 0 | 12.0 |
| flour + Starch powder) | | |
| % by mass | | |

When the donut of Example 8 was eaten, the moist feeling, the meltability in mouth, and the crispness were excellent even after storage for 7 days as compared with Control Example 4.

(Production Example 1 of Mixed Flour)

60 g of the starch powder 2 was added to 940 g of the soft flour and mixed well to obtain a mixed flour for a baked confectionery.

(Production Example 2 of Mixed Flour)

100 g of the starch powder 3 and 100 g of the sugar were added to 100 g of the soft flour and mixed well to obtain a mixed flour for a baked confectionery.

### Example 9 and Control Example 5

In the present example, a pancake was prepared and evaluated. Table 6 shows blending for the pancake.

(Method for Producing Pancake)

A pancake was prepared by the following procedure.

1. The oil and fat product 7, the whole eggs, the milk, the white sugar, and the water were placed in a bowl and stirred uniformly with a hobart mixer equipped with a whisk until the specific gravity reached 0.25 to 0.28.

2. The starch powder, the soft flour, and the baking powder were added to above 1, and mixed uniformly. In the control example, the soft flour and the baking powder were added and mixed uniformly.

3. The oil and fat product 8 which was heated and melted at 50° C. was added to above 2, and mixed uniformly to obtain a dough for the pancake.

4. 55 g of the dough obtained in above 3, was baked on a hot plate using a cercle having a diameter of 10 cm under the following conditions.

Baking temperature: 170° C.

Baking time: 6 minutes on one side, 3 minutes by turning over

5. The obtained pancake was completely cooled, and then was placed in a plastic bag, sealed, and stored at 4° C. for 2 weeks.

TABLE 6

| | Control | |
|---|---|---|
| | Example 5 | Example 9 |
| Kind of starch powder | — | Starch |
| | | powder 2 |
| Raw material (part(s) by mass) | | |
| Soft flour | 100 | 80 |
| Starch powder 2 | | 20 |
| White sugar | 50 | 50 |
| Baking powder | 5 | 5 |
| Oil and fat product 7 | 15 | 15 |
| Oil and fat product 8 | 30 | 30 |
| Whole egg | 120 | 120 |
| Milk | 30 | 30 |
| Water | 30 | 60 |
| Total (part(s) by mass) | 380 | 410 |
| Starch powder/(Powder raw | 0 | 12.9 |
| material + Starch powder) | | |
| % by mass | | |
| Starch powder/(Cereal | 0 | 20.0 |
| flour + Starch powder) | | |
| % by mass | | |

Compared with the pancake of Control Example 5, the pancake obtained in Example 9 had good meltability in mouth even after storage at 4° C. for 2 weeks, and was moist and had a good texture.

### Example 10 and Control Example 6

In the present example, a waffle was prepared and evaluated. Table 7 shows the blending for the waffle.

(Method for Producing Waffle)

1. White sugar, honey, whole eggs, milk, water, and the oil and fat product 7 were mixed using a whisk until the specific gravity was about 0.25 to 0.28. In Control Example, the materials were mixed in the same procedure except that the water was not added.

2. The soft flour, the starch powder 2, and the baking powder were added to above 1, and then the melted oil and fat product 9 was added and mixed to obtain a dough having a final dough specific gravity of about. 0.38 to 0.41. In Control Example, the dough was obtained by the same procedure except that the starch powder was not added.

3. This dough was baked in a waffle machine for about 1 minute and 45 seconds to obtain the waffle.

4. The obtained waffle was completely cooled, and then was placed in a plastic bag, sealed, and stored at 4° C. for 2 weeks.

TABLE 7

| | Control | Example |
|---|---|---|
| | Example 6 | 10 |
| Kind of starch powder | — | Starch |
| | | powder 2 |
| Raw material (part(s) by mass) | | |
| Soft flour | 100 | 80 |
| Starch powder 2 | | 20 |
| White sugar | 60 | 60 |
| Baking powder | 1 | 1 |
| Oil and fat product 7 | 15 | 15 |
| Oil and fat product 9 | 20 | 20 |
| Honey | 20 | 20 |
| Whole egg | 160 | 160 |
| Milk | 30 | 30 |
| Water | | 40 |
| Total (part(s) by mass) | 406 | 446 |
| Starch powder/(Powder raw | 0 | 12.4 |
| material + Starch powder) | | |
| % by mass | | |
| Starch powder/(Cereal | 0 | 20.0 |
| flour + Starch powder) | | |
| % by mass | | |

Compared with the waffle of Control Example 6, the waffle obtained in Example 10 had good meltability in mouth even after storage at 4° C. for 2 weeks, and was moist and had a good texture.

### Example 11 and Control Example 7

In the present example, a corn dog was prepared and evaluated. Table 8 shows the blending for the corn dog.

(Method for Producing Corn Dog)

1. The soft flour, the starch powder, the baking powder, and the white sugar were well mixed to prepare a mixed flour. In the control example, the soft flour, the baking powder, and the white sugar were well mixed to prepare a mixed flour.

2. The whole egg and the water were added to the mixed flour obtained in above 1, and mixed, and the oil and fat product 10 (rapeseed oil) was further mixed to obtain a batter solution.

3. A sausage was sprinkled with soft flour, soaked in a batter solution, and fried at 175° C. for 4 minutes to obtain the corn dog.

TABLE 8

| | Control | Example |
|---|---|---|
| | Example 7 | 11 |
| Kind of starch powder | — | Starch |
| | | powder 2 |
| Raw material (part(s) by mass) | | |
| Soft flour | 47 | 36 |
| Starch powder 2 | | 5 |
| White sugar | 13 | 13 |
| Baking powder | 1 | 1 |
| Oil and fat product 10 | 5 | 5 |
| Whole egg | 9 | 9 |
| Water | 25 | 31 |
| Total (part(s) by mass) | 100 | 100 |
| Starch powder/(Powder raw | 0 | 9.1 |
| material + Starch powder) | | |
| % by mass | | |
| Starch powder/(Cereal | 0 | 12.2 |
| flour + Starch powder) | | |
| % by mass | | |

The corn dog obtained in Example 11 had a good texture that was soft, and had the moist feeling and the good meltability in mouth, even when stored in a hot warmer at 75° C. for 3 hours, as compared with the corn dog of Control Example 7.

Priority is claimed on Japanese Patent Application No. 2018-147022, filed on Aug. 3, 2018, the entire disclosure of which is incorporated herein.

1. An improver for a baked confectionery (here, excluding a sponge cake) comprising:
a component (A) satisfying conditions of (1) to (5) below as an active ingredient,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

2. The improver for a baked confectionery according to claim 1, wherein the starch having an amylose content of equal to or more than 5% by mass is corn starch having an amylose content of equal to or more than 40%.

3. The improver for a baked confectionery according to claim 1,
wherein the molecular weight-reduced starch is one or more selected from the group consisting of acid-treated starch, oxidation-treated starch, and enzyme-treated starch.

4. The improver for a baked confectionery according to claim 1,
wherein the component (A) contains, as starch other than the molecular weight-reduced starch, one or more selected from the group consisting of corn starch, wheat starch, potato starch, tapioca starch, and crosslinked starch.

5. The improver for a baked confectionery according to claim 1,
wherein the baked confectionery is one selected from the group consisting of a pound cake, a madeleine, a pancake, a waffle, a corn dog, and a donut.

6. The improver for a baked confectionery according to claim 1,
wherein a content of the component (A) on a sieve having a mesh size of 0.075 mm is equal to or more than 10% by mass and equal to or less than 100% by mass.

7. A dough for a baked confectionery (here, excluding a sponge cake) comprising:
a component (A) satisfying conditions of (1) to (5) below; and
a powder raw material other than the component (A),
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

8. The dough for a baked confectionery according to claim 7,
wherein a content of the component (A) with respect to a total content of the powder raw material and the component (A) in the dough for a baked confectionery is equal to or more than 0.3% by mass and equal to or less than 25% by mass.

9. The dough for a baked confectionery according to claim 7,
wherein the powder raw material contains a cereal flour.

10. A mixed flour for a baked confectionery (here, excluding a sponge cake) comprising:
a component (A) satisfying conditions of (1) to (5) below; and
one or two selected from the group consisting of a cereal flour and sugars,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

11. A baked confectionery (here, excluding a sponge cake) comprising:
a component (A) satisfying conditions of (1) to (5) below; and
a powder raw material other than the component (A),
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

12. The baked confectionery according to claim 11,
wherein a content of the component (A) with respect to a total content of the powder raw material and the component (A) in the baked confectionery is equal to or more than 0.3% by mass and equal to or less than 25% by mass.

13. The baked confectionery according to claim 11,
wherein the powder raw material contains a cereal flour.

14. A method for producing a baked confectionery (here, excluding a sponge cake) comprising:
a step of mixing a component (A) satisfying conditions of (1) to (5) below and a powder raw material other than the component (A) to obtain a dough; and
a step of baking or frying the dough,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

15. A method for improving a texture of a baked confectionery (here, excluding a sponge cake), comprising:
incorporating a component (A) satisfying conditions of (1) to (5) below into a dough of the baked confectionery,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.

16. A method for suppressing a change over time of a baked confectionery (here, excluding a sponge cake), comprising:
incorporating a component (A) satisfying conditions of (1) to (5) below into a dough of the baked confectionery,
(1) a starch content is equal to or more than 75% by mass,
(2) equal to or more than 3% by mass and equal to or less than 45% by mass of molecular weight-reduced starch of starch having an amylose content of equal to or more than 5% by mass is contained, where the molecular weight-reduced starch has a peak molecular weight of equal to or more than 3×10³ and equal to or less than 5×10⁴,
(3) a degree of swelling in cold water at 25° C. is equal to or more than 5 and equal to or less than 20,
(4) a content under a sieve having a mesh size of 0.25 mm is equal to or more than 80% by mass and equal to or less than 100% by mass, and
(5) a content on a sieve having a mesh size of 0.5 mm is equal to or less than 10% by mass.
